(19) United States
(12) Patent Application Publication
(10) Pub. No.: US 2003/0137259 A1
(43) Pub. Date: Jul. 24, 2003

(54) Circuit for controlling power source for xenon lamps and signal lighting device adopting the same

(76) Inventor: Kwang-ik Hyun, Seoul (KR)

Correspondence Address: NIXON & VANDERHYE P.C., 8th Floor, 1100 North Glebe Rd., Arlington, VA, 22201-4714, US

(21) Appl. No.: 10/253,610

(22) Filed: Sep. 25, 2002

(30) Foreign Application Priority Data
Jan. 18, 2002 (KR) 2002-2995

(51) Int. Cl. G05F 1/00

(52) U.S. Cl. 315/291; 315/312

(57) ABSTRACT

A power source control circuit for a gas discharging tube, for example, a xenon lamp, and a xenon lamp signal lighting device adopting the same, are provided, in which power can be supplied for a relatively long time to a plurality of xenon lamps having a high starting voltage and a large lamp current with a small capacity battery, and a designation of emission and/or a flickering interval of at least one xenon lamp of a multi-color filter type can be easily controlled. The battery operated power source control circuit includes a logic controller for controlling operation of a xenon lamp according to a control process of an analog logic circuit, and a power management circuit for converting a lower voltage supplied from the batteries into a high voltage only when the xenon lamp is activated under the control of the logic controller, whereby a designation of emission and/or flickering intervals of xenon lamps of a multi-color filter type can be easily controlled by a user depressing a button switch to control the power source voltage. The power management circuit includes a DC-to-DC converter for converting a battery DC voltage into a first DC voltage under the control of the logic controller, a voltage converter for converting the first DC voltage into a second DC voltage higher than the first DC voltage under the control of the DC-to-DC converter, a starter for converting the second DC voltage into an alternating high voltage higher than the second DC voltage, to thereby supply the alternating high voltage to the xenon lamp, and a switching device for switching the power source voltage applied from the starter to the xenon lamp under the control of the logic controller. The power management circuit further includes a DC-to-DC converter for maintaining the voltage output from the batteries to be constant, in order to apply a constant voltage to the logic controller since the voltage from the batteries is reduced gradually in use. The logic controller and the DC-to-DC converters are integrated in a single integrated circuit, to realize a custom IC (ASIC), to thereby enable a xenon lamp signal lighting system to be made compact. A small capacity battery can be used for long at maximum.

### BACKGROUND OF THE INVENTION

1. Field of the Invention

The present invention relates to a power source control circuit for a gas discharging tube, for example, a xenon lamp, and a xenon lamp signal lighting device adopting the same, and more particularly, to a xenon lamp power source and a xenon lamp signal lighting device adopting the same, in which power can be supplied for a relatively long time to a plurality of xenon lamps having a high starting voltage and a large lamp current with a small capacity battery, and a designation of emission and/or a flickering interval of at least one xenon lamp of a multi-color filter type can be easily controlled.

2. Description of the Related Art

In general, a xenon lamp whose emission tube is elongate is widely used, and a pressure of the xenon gas filled in the xenon lamp is 1 to 10 atmosphere. Since a general xenon lamp has a low lamp voltage and a large lamp current, it has a high luminance characteristic. However, since an internal gas pressure is kept at the state of a high pressure, it is difficult to fill and seal a xenon lamp with a high pressure gas at the time of fabrication in comparison with a high pressure mercury lamp. Also, it is demerit to have to apply a high starting voltage to the xenon lamp, in order to start it. Thus, it is necessary to install a separate starter for applying a high voltage to a xenon lamp at the time of starting it. Although the xenon lamp has the above-described starter required, since light emitted from the xenon lamp is very close to natural light, it does not make the human eyes much fatigued. Also, since the xenon lamp filled and sealed with the high pressure xenon gas during manufacturing does not evaporate the xenon gas from the low pressure state to the high pressure state slowly with a discharging heat as in the high pressure mercury lamp, it is possible to perform an instantaneous flash and an instantaneous re-start during starting differently from the mercury lamp. As a result, since the xenon lamp has a high luminance in comparison with an area of a light emitter, it is widely used as a light projector or a signal lighting source. In particular, since the xenon lamp emits light close to visible light, its use is further extended. Also, although power has been supplied to a xenon lamp using a large capacity battery in automobiles or airplanes up to now, an efficiency of a high voltage conversion circuit is not so good. Accordingly, the portable xenon lamp is not so practical. Further, in the case that a microcomputer is used as a power source switching control circuit for a xenon lamp, an amount of power supplied through a voltage battery is increased according to a power consumption of the microcomputer itself Accordingly, the battery should be exchanged with a new one from time to time. Also, since the number of components is increased, its production cost cannot but increase and a xenon lamp signal lighting device cannot be designed lighter, thinner, shorter and smaller.

### SUMMARY OF THE INVENTION

To solve the above problems, it is an object of the present invention to provide a xenon lamp power source controlling circuit and a xenon lamp signal lighting device adopting the same, in which the replacement cycles of batteries are lengthened by economically controlling a power source with a custom application specific integrated circuit (ASIC) formed of integrated logic circuits instead of digitally controlling power supplied to a xenon lamp from batteries by using a microcomputer.

It is another object of the present invention to provide a xenon lamp power source controlling circuit and a xenon lamp signal lighting device adopting the same, which includes a DC-to-DC converter in order to maintain a power source voltage supplied from batteries to be constant.

It is still another object of the present invention to provide a xenon lamp power source controlling circuit and a xenon lamp signal lighting device adopting the same, which is capable of performing a designation of emission and/or a flickering interval of xenon lamps of a multi-color filter type, according to operation of an analog logic circuit which is performed by a user who depresses a button switch simply.

To accomplish the above object of the present invention, there is provided a xenon lamp power source controlling circuit which operates by a power source voltage supplied from batteries, the xenon lamp power source controlling circuit comprising. a logic controller for controlling operation of a xenon lamp according to a control process of an analog logic circuit; and a power management circuit for converting a lower voltage supplied from the batteries into a high voltage only when the xenon lamp is activated under the control of the logic controller, whereby a designation of emission and/or flickering intervals of xenon lamps of a multi-color filter type can be easily controlled by a user depressing a button switch to control the power source voltage.

Preferably, the power management circuit comprises: a DC-to-DC converter for converting a battery DC voltage into a first DC voltage under the control of the logic controller; a voltage converter for converting the first DC voltage into a second DC voltage higher than the first DC voltage under the control of the DC-to-DC converter; a starter for converting the second DC voltage into an alternating high voltage higher than the second DC voltage, to thereby supply the alternating high voltage to the xenon lamp; and a switching device for switching the power source voltage applied from the starter to the xenon lamp under the control of the logic controller.

Preferably, the switching device comprises a switch which performs a switching operation under the control of the logic controller if the voltage output from the voltage converter completely charges a capacitor in such a manner that only a quantity consumed through a self-discharging of the xenon lamp is recharged.

Preferably, the power management circuit further comprises a DC-to-DC converter for maintaining the voltage output from the batteries to be constant, in order to apply a constant voltage to the logic controller since the voltage from the batteries is reduced gradually in use.

Preferably, the DC-to-DC converter comprises: a first comparator for comparing the output voltage fedback from the voltage converter with a reference voltage from a reference voltage generator, and outputting an oscillation control signal for an oscillator; and a second comparator for comparing the output signal from a current limiter with a reference voltage from the reference voltage generator, and outputting a drive control signal for the oscillator.

Preferably, the DC-to-DC converter further comprises a third comparator for comparing a reference voltage from the reference voltage generator with an output signal from a temperature detector, and outputting a thermally overheating prevention control signal for the oscillator.

In particular, the present invention achieves the logic controller and the DC-to-DC converters in a single integrated circuit, that is, realizes a custom IC (ASIC), to thereby enable a xenon lamp signal lighting system to be made compact, and thus attach it to a human body or a bicycle so as to be more conveniently used.

There is also provided a battery operated xenon lamp signal lighting device comprising: a case having a battery chamber located at the lower end of the case, in which at least one battery is contained, and a lamp holder chamber located at the upper end of the case, in which at least one xenon lamp is fitted; at least one button switch installed on the outer surface of the case, in order for a user to control a designation of emission and/or a flickering interval of the xenon lamp; and a control circuit installed between the battery chamber and the xenon lamp holder chamber in the case, in which the battery power voltage is intermittently supplied to the xenon lamp to thus control flickering of the xenon lamp.

Preferably, a cover covering the xenon lamp holder chamber is formed by adopting a color filter so that visible light emitted from the xenon lamp represents a multi-color.

Preferably, the color filter represents the multi-color by inserting a different color filter into the cover.

Preferably, the xenon lamp signal lighting device comprises a hanger or clip on the case so as to be attached to a human body, a bicycle, a car etc., and to be portable in handy.

### BRIEF DESCRIPTION OF THE DRAWINGS

The above objects and other advantages of the present invention will become more apparent by describing the preferred embodiment thereof in more detail with reference to the accompanying drawings in which:

FIG. 1 is a circuitry diagram showing a general lighting circuit for a gas discharging tube such as a xenon lamp;

FIG. 2 is a circuitry diagram showing a power source control circuit for a gas discharging tube such as a xenon lamp according to the present invention;

FIG. 3 is a detailed circuitry diagram showing a DC-DC converter shown in FIG. 2; and

FIG. 4 is a perspective view showing an external appearance of a gas discharging device to which the power source control circuit according to the present invention is applied, that is, a xenon lamp signal lighting device.

### DETAILED DESCRIPTION OF THE INVENTION

A preferred embodiment of the present invention will be described with reference to the accompanying drawings.

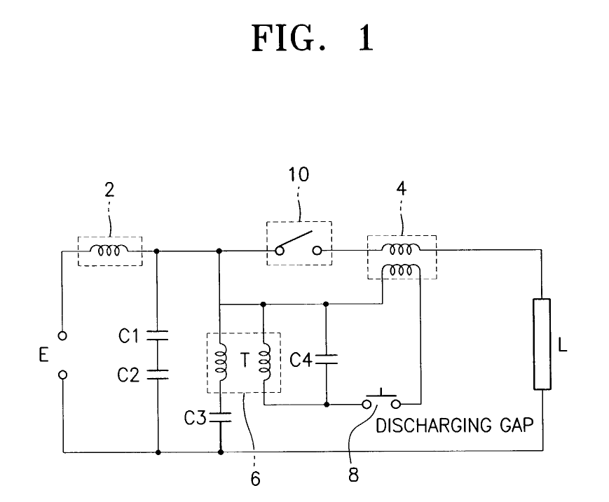

As shown in FIG. 1 showing a general lighting circuit for a gas discharging tube such as a xenon lamp, a power source voltage from a power source E passes a stabilizer 2 and is applied to a pulse transformer 4 through smoothing capacitors C1 and C2, so that a pulse transformed signal is supplied to a starter 6. The starter 6 is formed of trigger coils T in which a high-tension voltage is induced and thus a discharging start voltage is supplied to a xenon lamp L through a discharging gap 8. In FIG. 1, a reference symbol C3 denotes a surge current prevention capacitor and C4 denotes is a smoothing capacitor for providing the start voltage to the discharging gap consistently. Once a discharging has been performed, a constant lamp voltage is maintained in the discharging lamp L, to thereby discharge steadily. In the case that an alternating power source is used for the xenon lamp, there is no need to manage power. However, in the case that batteries are for a power source E, and a switching device 10 for controlling a pulse voltage to be intermittently applied to a xenon lamp is controlled by a microcomputer (not shown), power consumption becomes large because of power consumed in the microcomputer. Accordingly, batteries should be often replaced to make users inconvenienced. Also, peripheral devices for the microcomputer are needed.

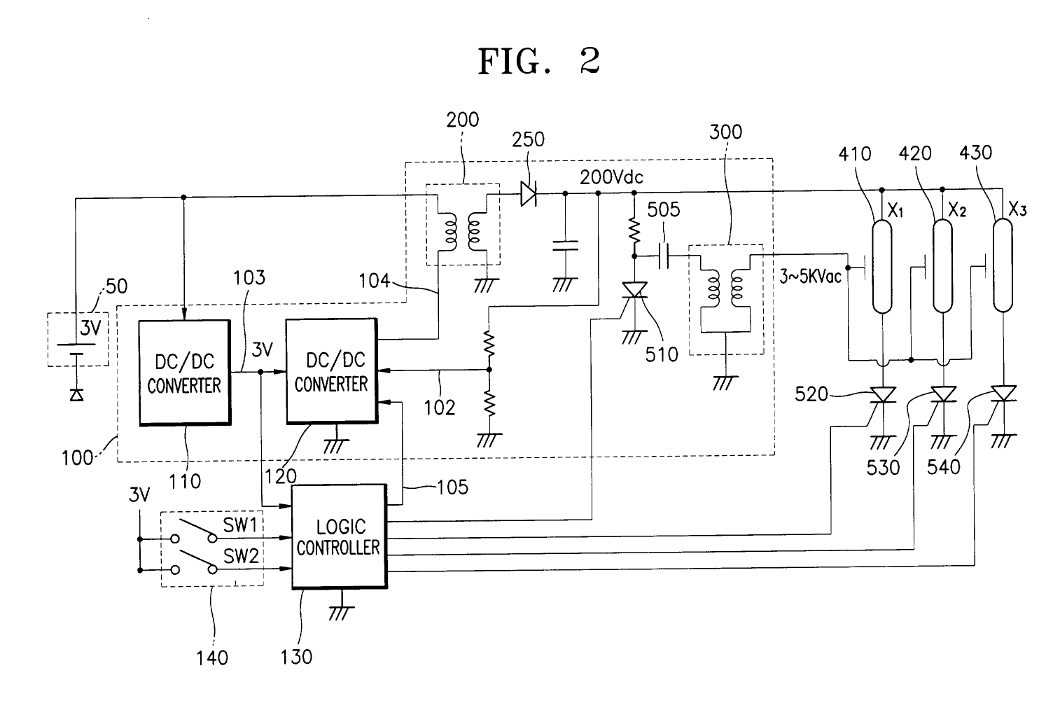

The present invention provides a battery operated xenon lamp signal lighting device in order to solve the conventional problems. Referring to FIGS. 2 through 4, a configuration and operation of a power source control circuit for a gas discharging tube such as a xenon lamp will be described in more detail.

FIG. 2 is a circuitry diagram showing a power source control circuit for a gas discharging tube such as a xenon lamp according to the present invention. Referring to FIG. 2, the power source control circuit which operates by a power source voltage supplied from batteries 50, according to the present invention includes a logic controller 130 for controlling operation of a xenon lamp according to a control process of an analog logic circuit, under a user's manipulation of a button switch 140, and a power management circuit 100 for converting a lower voltage supplied from the batteries 50 into a high voltage only when the xenon lamp is activated, under the control of the logic controller 130, so that the xenon lamp is switching controlled.

The power management circuit 100 includes a DC-to-DC converter 120 for converting a battery DC voltage into a first DC voltage under the control of the logic controller 130, a voltage converter 200 for converting the first DC voltage into a second DC voltage higher than the first DC voltage under the control of the DC-to-DC converter 120, a starter 300 for converting the second DC voltage into an alternating high voltage higher than the second DC voltage under the control of the logic controller 130, to thereby supply the alternating high voltage to the xenon lamp, and switching devices 520-540 for switching the power source voltage applied from the starter 300 to the xenon lamp under the control of the logic controller 130.

Through the above-described configuration, the xenon lamp power source control circuit according to the present invention receives power from a battery 50 and controls flickering of xenon lamps 410-430 under the control of the logic controller 130. The logic controller 130 receives power under the manipulation of a button switch (SW1 or SW2) 140, and controls the operations of at least one xenon lamp (X1, X2 or X3) 410, 420 or 430, according to a control process of a logic circuit.

Also, the power management circuit 100 further includes a DC-to-DC converter 110 for maintaining the voltage output from the batteries to be constant, in order to apply a constant voltage to the logic controller 130 since the voltage from the batteries is reduced gradually in use. Here, the present invention achieves the logic controller 130 and the DC-to-DC converters 110 and 120 in a single integrated circuit, that is, realizes a custom IC (ASIC), to thereby enable a xenon lamp signal lighting system having xenon lamps 410-430 to be made compact, and thus attach it to a human body or a bicycle so as to be more conveniently used.

In FIG. 2, batteries are used as a power source. In this embodiment, two 1.5V batteries are used to supply 3V. The 3V DC voltage is transformed into an AC voltage of 200V in the voltage converter 200. In FIG. 2, a diode indicated by a reference numeral 250 denotes a rectifying diode. In FIG. 2, switching devices 510-540 can be embodied by using a silicon controlled rectifier device which is turned on and off according to a control signal input to its gate, respectively. The DC voltage 200Vdc increased in the voltage converter 200 is converted into an AC high voltage 3-5 kV for starting the xenon lamps.

The button switches 140 of FIG. 2 has been designed into two button switched in this embodiment. The number of the button switches may be determined as necessary as design requirement. Here, a switch SW1 provides the logic controller 130 with a signal for connecting or disconnecting power to be supplied to the xenon lamps. Here, a repetitive pressing of the switch SW1 controls an interval of emission of at least one xenon lamp 410, 420 or 430. For example, an interval of emission of the xenon lamps can be selectively controlled to be 0.5 seconds for one-time pressing, one second for twice pressing, 1.5 seconds for three-times pressing. Another switch SW2 plays a role of selecting a xenon lamp. For example, the switch SW2 may be designed so that when the switch SW2 is depressed once, the xenon lamps X1, X2 and X3 flicker in turn. Also, the switch SW2 may be designed so that whenever the switch SW2 is depressed once more, two xenon lamps X1 and X2, X2 and X3, and X3 and X1 flicker in turn. The switch SW2 may be designed so that when the switch SW2 is depressed, the xenon lamp X1, X2 or X3 flickers randomly. Since the switching operation of the xenon lamps can be easily designed by one skilled in the art through an analog logic circuit (not shown) installed in the logic controller 130, the detailed description thereof will be omitted. In the present invention, a basic scheme of power saving in the power management will be described.

A basic power management in the present invention is firstly to use electronic devices operating at low voltage. An initial voltage of a battery is 1.5V, but the battery voltage is lowered down to 0.7V or less as it is used for long. The battery life is finished at 0.7V or less. In the case that two batteries are connected in series, the battery voltage can be obtained from 3.0V at maximum to 1.4V at minimum. As an example, if electronic components which can operate at the battery minimum voltage of 1.4V are used, a power source control circuit still works although the battery voltage is reduced. Secondly, since the battery voltage from 3.0V at maximum to 1.4V at minimum should be converted into 200V in the present invention, a DC step-up conversion efficiency should be enhanced. In the present invention, high efficient transformer and switching devices should be adopted. Thirdly, if the 200V output generated in the DC voltage converter 200 completely charges a capacitor 505, a switching device 510 operates to make the DC-to-DC converter 120 stop. Thereafter, the capacitor 505 is charged as much as an amount consumed by a self-discharging (natural discharging) of the xenon lamp.

By doing so, the present invention has solved a problem that an AA type battery cannot but be used for only 2-5 hours in the case that the xenon lamps continue to work since a battery capacity is 3V or so. That is, the present invention employs the power management scheme and thus controls the switching device 510 to operate so that a DC high voltage is applied to the starter 300 only when the xenon lamp starts, to thereby reduce a power consumption at the time of starting the xenon lamp. As a result, the batteries can be used for a long time, for example, for 20 hours or longer. Thus, if the power source control circuit for xenon lamps according to the present invention is adopted, light close to the visible light can flicker as desired. Accordingly, a xenon lamp signal lighting device adopting the power source control circuit according to the present invention may be attached to a human body, a bicycle, an automobile car, etc., or held portably, to thus properly indicate location of the object having the xenon lamp signal lighting device.

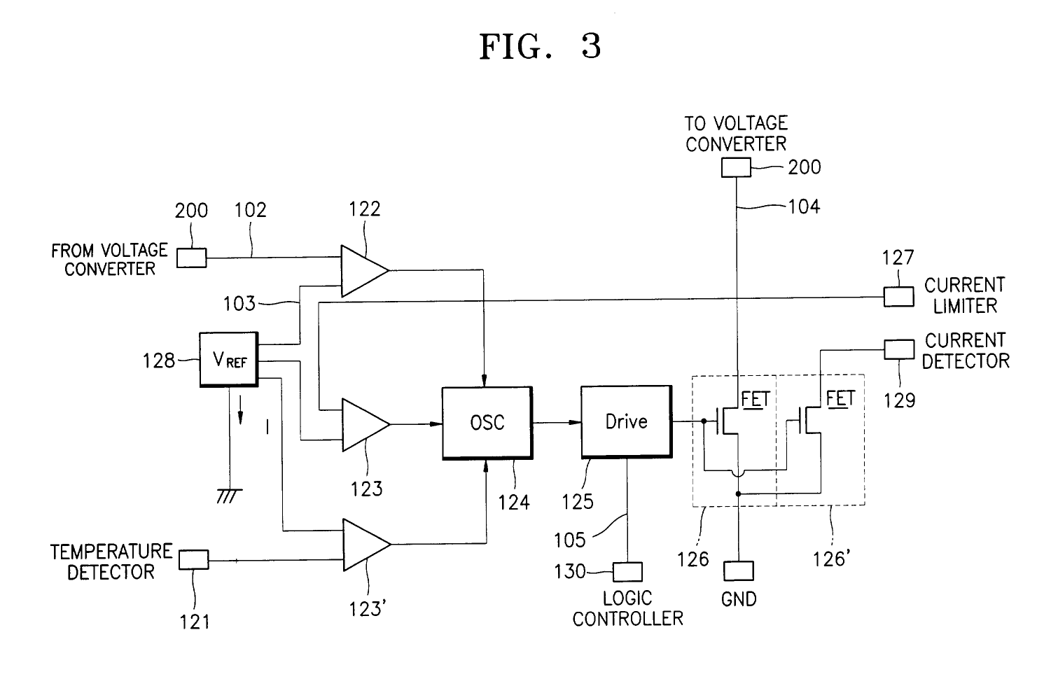

The xenon lamp signal lighting device according to the present invention includes a DC-to-DC converter 120 for pulse-width-controls the voltage converter 200 for converting the DC low voltage of 3V into a DC high voltage of 200V needed in the starter 300 and the xenon lamps. The operation of the DC-to-DC converter 120 will be described with reference to FIG. 3. FIG. 3 is a detailed circuitry diagram showing a DC-DC converter 120 shown in FIG. 2. The DC-to-DC converter 120 of FIG. 3 includes an oscillator (OSC) 124 generating an oscillating frequency by comparing a desired voltage with a reference voltage, a drive controlling a driving voltage generator 126 to be driven according to the oscillation frequency signal from the oscillator 124 and the driving voltage control signal 105 from the logic controller 130, and a FET driving voltage generator 126 which receives the voltage control signal from the drive 125 and generates a driving voltage 104 for the voltage converter 200. A first comparator 122 compares the output signal 102 fedback from the voltage converter 200 with a reference voltage 103 from a reference voltage generator 128, and outputs an oscillation control signal for an oscillator 124. A second comparator 123 compares the output signal from a current limiter 127 with a reference voltage from the reference voltage generator 128, and outputs a drive control signal for the oscillator 124. The FET driving voltage generator 126 generates the driving voltage 104 for the voltage converter 200 under the control of the drive 125. Meanwhile, a FET driving current generator 126′ outputs a FET driving current. The driving current output from the FET driving current generator 126′ is detected in a current detector 129. The current detector 129 gives a current limit signal to the current limiter 127 according to the current detected in the current detector 129, in order to control an oscillation control signal to be input to the oscillator 124. The current detector 129 plays a role of protecting the FET devices from overcurrent. Also, the DC-to-DC converter 120 of the present invention further includes a third comparator 123′. The third comparator 123′ compares a reference temperature voltage from the reference voltage generator 128 with a temperature voltage detected in a temperature detector 121, and outputs a thermally overheating prevention control signal for the oscillator 124.

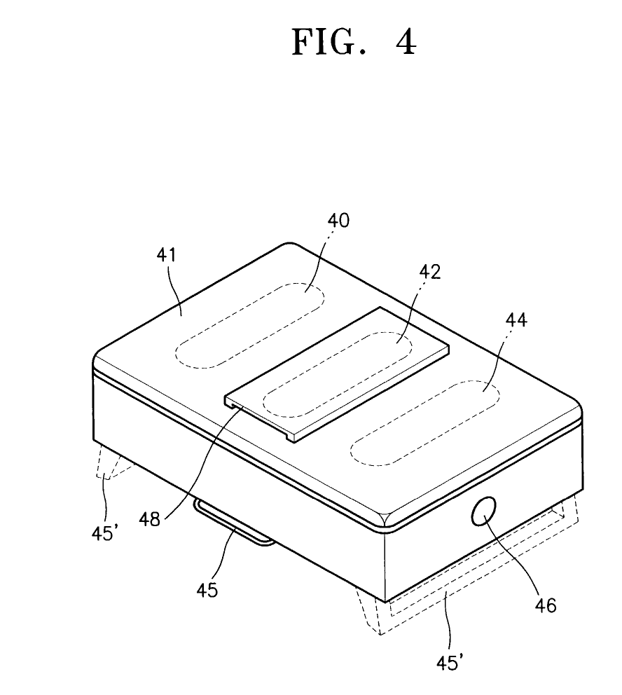

FIG. 4 is a perspective view showing an external appearance of a gas discharging device to which the power source control circuit according to the present invention is applied, that is, a xenon lamp signal lighting device. An illuminating device adopting a xenon lamp power source control circuit according to the present invention is a xenon lamp signal lighting device operating at the battery voltage of 3V. The xenon lamp signal lighting device includes a case 41 having a battery chamber located at the lower end of the case 41, in which at least one battery is contained, and a lamp holder chamber located at the upper end of the case, in which at least one xenon lamp is fitted. The lamp holder chamber is provided with a reflection mirror reflecting the light emitted from the lamp. At least one button switch 46 is installed on the outer surface of the case, in order for a user to control a designation of emission and/or a flickering interval of the xenon lamp. A control circuit is installed between the battery chamber and the xenon lamp holder chamber in the case 41, in which the battery power voltage is intermittently supplied to the xenon lamp to thus control flickering of the xenon lamp. A cover covering the xenon lamp holder chamber is formed by adopting a color filter so that visible light emitted from the xenon lamp represents a multi-color. The color filter represents the multi-color by inserting a different color filter into the cover. The xenon lamp signal lighting device includes a hanger or clip on the case so as to be attached to a human body, a bicycle, a car etc., and to be portable in handy.

As shown in FIG. 4, in the case that three xenon lamps 40, 42 and 44 are used by colors R, G and B, a filter insertion fitter 48 for fitting a color filter is provided so that the color of the xenon lamp installed in the middle of three xenon lamps can be changed by using the color filter. Although only the middle xenon lamp has been fitted with a color filter in FIG. 4, a filter insertion fitter can be provided with respect to other xenon lamps. Also, the illumination device according to the present invention includes a hanger 45 so as to be easily attached to a human body, a bicycle, and an automobile car, in which a strip is bound around the hanger 45 for easy attachment to the human body, etc. In FIG. 4, the hanger 45 is located in the middle of the lower portion of the case 41. However, hangers 45′ may be located respectively in the lower ends of the side portions as desired. In the present invention, a hanger 45 or 45′ can be embodied in various forms. In FIG. 4, the hanger 45 is embodied into a strap fitting hanger, in which a strap (not shown) is fitted into the hanger 45. The hanger is fitted with a strap so as to be easily attached to the head, arm, leg, etc. Also, the hanger can be embodied into a clip similar to the case applied to a fountain pen, in which case the clip-typed hanger can be easily fitted into a waist strap, the entrance of a pocket, a goggle strap, etc.

Also, a button switch 46 is provided on one side of the case 41. The xenon lamps can be easily controlled through user's manipulation of the button switch. When the power source control circuit according to the present invention is made of custom ICs, the xenon lamp signal lighting device according to the present invention is also made compact. Also, since a battery power source is used in the present invention, the xenon lamp signal lighting device according to the present invention can be used irrespective of existence of a commercial power supply. Power used in the xenon lamps and the control circuit is managed, to thereby minimize a battery power consumption and enable a small capacity battery to be used for long.

As described above, the power source control circuit according to the present invention enables xenon lamps emitting light close to visible light and each having a high luminance to be used for a relatively long time with a small capacity battery. In the case that the light emitted from the xenon lamps is controlled to flicker, the light can be seen far. In particular, in the case that the xenon lamp signal lighting device is attached to-a human body or bicycle, the xenon lamp signal lighting device plays a role of providing viewer with a position identifier as well as a decorative appearance. Accordingly, when a person who rides a ski or roller-skate uses a xenon lamp signal lighting device, an safety accident can be prevented.

What is claimed is:

1. A xenon lamp power source controlling circuit which operates by a power source voltage supplied from batteries, the xenon lamp power source controlling circuit comprising:
a logic controller for controlling operation of a xenon lamp according to a control process of an analog logic circuit; and
a power management circuit for converting a lower voltage supplied from the batteries into a high voltage only when the xenon lamp is activated under the control of the logic controller, whereby a designation of emission and/or flickering intervals of xenon lamps of a multi-color filter type can be easily controlled by a user depressing a button switch to control the power source voltage.

2. The xenon lamp power source controlling circuit of claim 1, wherein said power management circuit comprises: a DC-to-DC converter for converting a battery DC voltage into a first DC voltage under the control of the logic controller; a voltage converter for converting the first DC voltage into a second DC voltage higher than the first DC voltage under the control of the DC-to-DC converter; a starter for converting the second DC voltage into an alternating high voltage higher than the second DC voltage, to thereby supply the alternating high voltage to the xenon lamp; and a switching device for switching the power source voltage applied from the starter to the xenon lamp under the control of the logic controller.

3. The xenon lamp power source controlling circuit of claim 2, wherein said switching device comprises a switch which performs a switching operation under the control of the logic controller if the voltage output from the voltage converter completely charges a capacitor in such a manner that only a quantity consumed through a self-discharging of the xenon lamp is recharged.

4. The xenon lamp power source controlling circuit of claim 1, wherein said power management circuit further comprises a DC-to-DC converter for maintaining the voltage output from the batteries to be constant, in order to apply a constant voltage to the logic controller since the voltage from the batteries is reduced gradually in use.

5. The xenon lamp power source controlling circuit of claim 4, wherein said DC-to-DC converter comprises: a first comparator for comparing the output voltage fedback from the voltage converter with a reference voltage from a reference voltage generator, and outputting an oscillation control signal for an oscillator; and a second comparator for comparing the output signal from a current limiter with a reference voltage from the reference voltage generator, and outputting a drive control signal for the oscillator.

6. The xenon lamp power source controlling circuit of claim 5, wherein said DC-to-DC converter further comprises a third comparator for comparing a reference voltage from the reference voltage generator with an output signal from a temperature detector, and outputting a thermally overheating prevention control signal for the oscillator.

7. The xenon lamp power source controlling circuit of claim 6, wherein said logic controller and said DC-to-DC converters are integrated in a single integrated circuit, to realize a custom IC (ASIC), to thereby enable a xenon lamp signal lighting system to be made compact.

8. A battery operated xenon lamp signal lighting device comprising:
a case having a battery chamber located at the lower end of the case, in which at least one battery is contained, and a lamp holder chamber located at the upper end of the case, in which at least one xenon lamp is fitted;
at least one button switch installed on the outer surface of the case, in order for a user to control a designation of emission and/or a flickering interval of the xenon lamp; and
a power source control circuit installed between the battery chamber and the xenon lamp holder chamber in the case, in which the battery power voltage is intermittently supplied to the xenon lamp to thus control flickering of the xenon lamp.

9. The battery operated xenon lamp signal lighting device of claim 8, further comprising a cover covering the xenon lamp holder chamber formed by adopting a color filter so that visible light emitted from the xenon lamp represents a multi-color.

10. The battery operated xenon lamp signal lighting device of claim 9, wherein said color filter represents the multi-color by inserting a different color filter into the cover.

11. The battery operated xenon lamp signal lighting device of claim 8, further comprising a hanger on the case so as to be attached to a human body, a bicycle, a car etc., and to be portable in handy.

12. The battery operated xenon lamp signal lighting device of claim 11, wherein said hanger is fitted with a strip so as to be easily attached to a human body, a bicycle, an automobile car, etc.

13. The battery operated xenon lamp signal lighting device of claim 11, wherein said hanger adopts a clip so as to be easily attached to a clothe, a bicycle, an automobile car, etc.

14. The battery operated xenon lamp signal lighting device of claim 8, wherein said xenon lamp power source controlling circuit comprises: a logic controller for controlling operation of a xenon lamp according to a control process of an analog logic circuit; and a power management circuit for converting a lower voltage supplied from the batteries into a high voltage only when the xenon lamp is activated under the control of the logic controller, whereby a designation of emission and/or flickering intervals of xenon lamps of a multi-color filter type can be easily controlled by a user depressing a button switch to control the power source voltage.

15. The battery operated xenon lamp signal lighting device of claim 14, wherein said power management circuit comprises: a DC-to-DC converter for converting a battery DC voltage into a first DC voltage under the control of the logic controller; a voltage converter for converting the first DC voltage into a second DC voltage higher than the first DC voltage under the control of the DC-to-DC converter; a starter for converting the second DC voltage into an alternating high voltage higher than the second DC voltage, to thereby supply the alternating high voltage to the xenon lamp; and a switching device for switching the power source voltage applied from the starter to the xenon lamp under the control of the logic controller.

16. The battery operated xenon lamp signal lighting device of claim 15, wherein said switching device comprises a switch which performs a switching operation under the control of the logic controller if the voltage output from the voltage converter completely charges a capacitor in such a manner that only a quantity consumed through a self-discharging of the xenon lamp is recharged.

17. The battery operated xenon lamp signal lighting device of claim 15, wherein said power management circuit further comprises a DC-to-DC converter for maintaining the voltage output from the batteries to be constant, in order to apply a constant voltage to the logic controller since the voltage from the batteries is reduced gradually in use.

18. The battery operated xenon lamp signal lighting device of claim 15, wherein said DC-to-DC converter comprises: a first comparator for comparing the output voltage fedback from the voltage converter with a reference voltage from a reference voltage generator, and outputting an oscillation control signal for an oscillator; and a second comparator for comparing the output signal from a current limiter with a reference voltage from the reference voltage generator, and outputting a drive control signal for the oscillator.

19. The battery operated xenon lamp signal lighting device of claim 15, wherein said DC-to-DC converter further comprises a third comparator for comparing a reference voltage from the reference voltage generator with an output signal from a temperature detector, and outputting a thermally overheating prevention control signal for the oscillator.

20. The battery operated xenon lamp signal lighting device of claim 19, wherein said logic controller and said DC-to-DC converters are integrated in a single integrated circuit, to realize a custom IC (ASIC), to thereby enable a xenon lamp signal lighting system to be made compact.
